(19) United States
(12) Patent Application Publication
(10) Pub. No.: US 2026/0064414 A1
(43) Pub. Date: Mar. 5, 2026

(54) PORT-SPECIFIC ARBITRATION SCHEME FOR REGISTER FILE

(71) Applicant: QUALCOMM Incorporated, San Diego, CA (US)

(72) Inventors: Akilesh KRISHNAMURTHY, San Jose, CA (US); Conrado BLASCO, San Mateo, CA (US)

(21) Appl. No.: 18/816,260

(22) Filed: Aug. 27, 2024

(51) Int. Cl. G06F 9/30; G06F 9/38

(52) U.S. Cl. CPC G06F 9/30043; G06F 9/3012; G06F 9/3836

(57) ABSTRACT

The present disclosure is directed to a method for writing to a register file of a processor. The method includes receiving a first instruction associated with a first execution unit of the processor, with the first instruction being associated with writing to one or more banks of a plurality of banks of the register file via a write port of the register file. The method includes determining a conflict between the first instruction and a second instruction associated with a second execution unit, with the second instruction being associated with writing to the one or more banks via the write port. The method includes performing one or more actions with respect to the first instruction and the second instruction based on determining the conflict.

Aspects of the present disclosure generally relate to register files partitioned into multiple banks of registers and, more particularly, to techniques for handling multiple execution pipelines sharing a write port of a register file and requesting to write to the same bank of the register file using the write port.

### BACKGROUND

A central processing unit (CPU) may include a register file that serves as a high-speed storage unit for data and addresses. The register file provides fast access to frequently used data and addresses to reduce the number of instances in which data and instructions are fetched from slower memory locations (e.g., main memory or cache). In this manner, the register file improves the performance of the CPU.

The register file typically includes a set of registers. The set of registers are high-speed storage locations that may be directly accessed by different logical sources (e.g., integer execution units, load-store units, etc.) of the CPU. In some instances, the set of registers may be banked (e.g., partitioned) into multiple banks, with each bank including a subset of the total registers included in the set of registers. By partitioning the register file into multiple banks, the CPU can access different registers in parallel allowing for concurrent read and write operations.

### BRIEF SUMMARY

In one aspect, a method for writing to a register file of a processor generally includes: receiving a first instruction associated with a first execution unit of the processor, the first instruction associated with writing to one or more banks of a plurality of banks of the register file via a write port of the register file; determining a conflict between the first instruction and a second instruction associated with a second execution unit, the second instruction associated with writing to the one or more banks via the write port; and performing one or more actions with respect to the first instruction and the second instruction based on determining the conflict.

In another aspect, an apparatus is provided. The apparatus includes a processing having a plurality of execution units and a register file having plurality of banks and a plurality of write ports, the processor configured to: receive a first instruction associated with a first execution unit of the plurality of execution units, the first instruction associated with writing to one or more banks of the plurality of banks of the register file via a write port of the plurality of write ports; determine a conflict between the first instruction and a second instruction associated with a second execution unit of the plurality of execution units, the second instruction associated with writing to the one or more banks via the write port; and perform one or more actions with respect to the first instruction and the second instruction based on determining the conflict.

In yet another aspect, a non-transitory computer-readable medium including instructions to be executed in a processor is provided. The instruction, when executed in the processor, cause the processor to: receive a first instruction associated with a first execution unit of the processor, the first instruction associated with writing to one or more banks of a plurality of banks of a register file via a write port of the register file; determine a conflict between the first instruction and a second instruction associated with a second execution unit, the second instruction associated with writing to the one or more banks via the write port; and perform one or more actions with respect to the first instruction and the second instruction based on determining the conflict.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts an architecture of a processor 100 according to various aspects of the present disclosure.

FIG. 2 depicts a processing pipeline for a central processing unit of a processor according to various aspects of the present disclosure.

FIG. 3 depicts a block diagram of logic for efficient register file write banking for a register file having multiple banks according to various aspects of the present disclosure.

FIG. 4 depicts a table illustrating an arbitration scheme for register file write banking for a register file having multiple banks according to various aspects of the present disclosure.

FIG. 5 depicts a method for clocking systolic stages of a systolic array on alternating edges of an input clock signal according to various aspects of the present disclosure.

FIG. 6 depicts an example processing system in which a central processing unit may be included according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques and apparatuses for efficient writing to a register file.

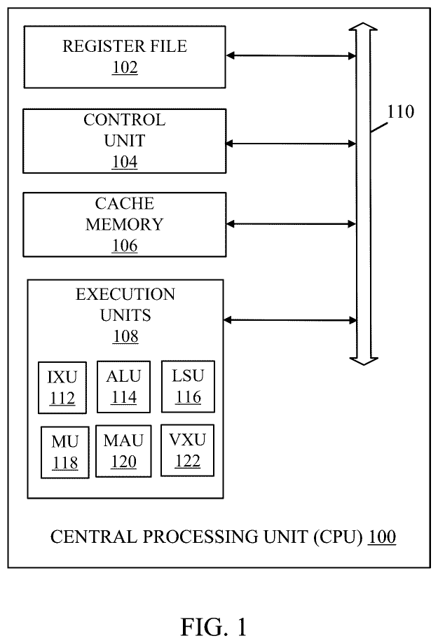

Example aspects are directed to processors, such as super scalar processors, that allow multiple instructions to be executed during a single clock cycle. As illustrated in FIG. 1, such processors typically include multiple execution units, with each execution unit including multiple pipelines. Multiple instructions may be distributed across the multiple pipelines for a given execution unit. In this manner, the given execution unit may execute multiple instructions concurrently (e.g., at the same time). To accommodate multiple instructions being executed during a single clock cycle, the register file of such processors must be sufficiently large (e.g., include enough physical registers). For instance, the register file must accommodate multiple instances of data being read from the register file (e.g., via read ports) during a single clock cycle, multiple instances of data being written to the register file (e.g., via write ports) during the single clock cycle, or both. The register file, however, includes a limited number of physical ports and adding additional physical ports has undesirable effects, such as increasing the size of the register file and increasing the power consumption of the register file.

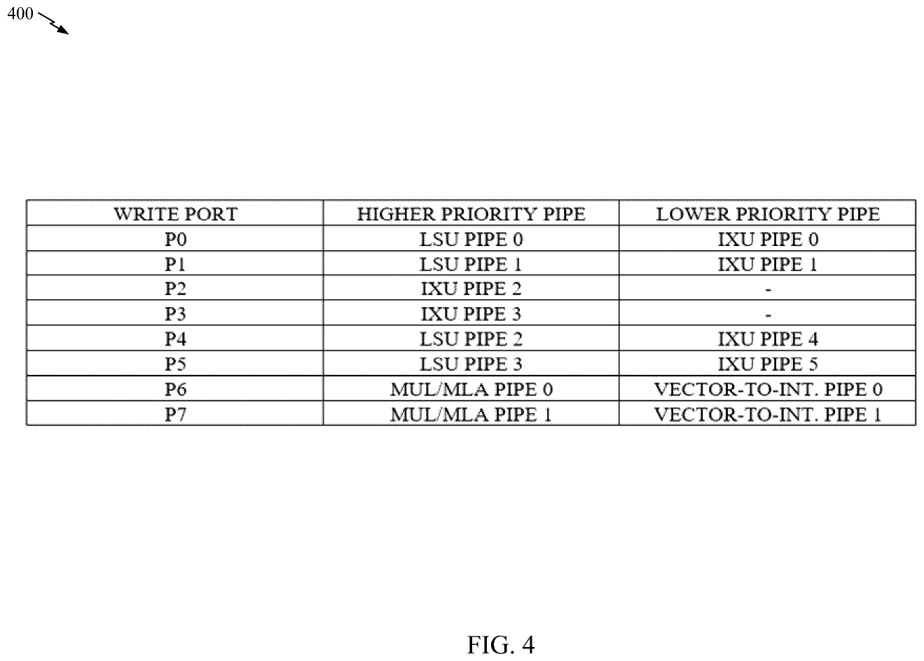

Example aspects of the present disclosure are directed to techniques for sharing the existing physical ports of the register file amongst the multiple pipelines. More specifically, the disclosed techniques are directed to a scheme for sharing write ports using a banked register file (that is, a register file partitioned into multiple banks of registers). For example, multiple pipelines (e.g., two different pipelines) may share the same write port of the register file and, as will be discussed in FIG. 4, an arbitration scheme may be implemented to handle two pipelines (e.g., executed by the same execution unit or different execution units) assigned to the same write port writing to the same bank (e.g., a subset of registers) of the register file during a given clock cycle. In this manner, the disclosed techniques allow the write ports of the register file to be shared in an efficient manner without affecting the performance (e.g., decreased throughput) of such processors and without incurring the undesirable effects (e.g., increased size, increased power consumption) associated with adding additional physical ports.

### Example Central Processing Unit (CPU)

FIG. 1 depicts an example CPU 100 according to some aspects of the present disclosure. For instance, the central processing unit 100 may be a superscalar processor that executes and issues multiple instructions at a time.

In some aspects, the CPU 100 includes a register file 102, a control unit 104, cache memory 106, and a plurality of execution units 118. Furthermore, in some aspects, the CPU 100 may include a local bus 110 connecting the different components (e.g., register file 102, control unit 104, cache memory 106, and execution units 108) to one another. In this manner, the components of the CPU 100 may communicate with one another via the local bus 110.

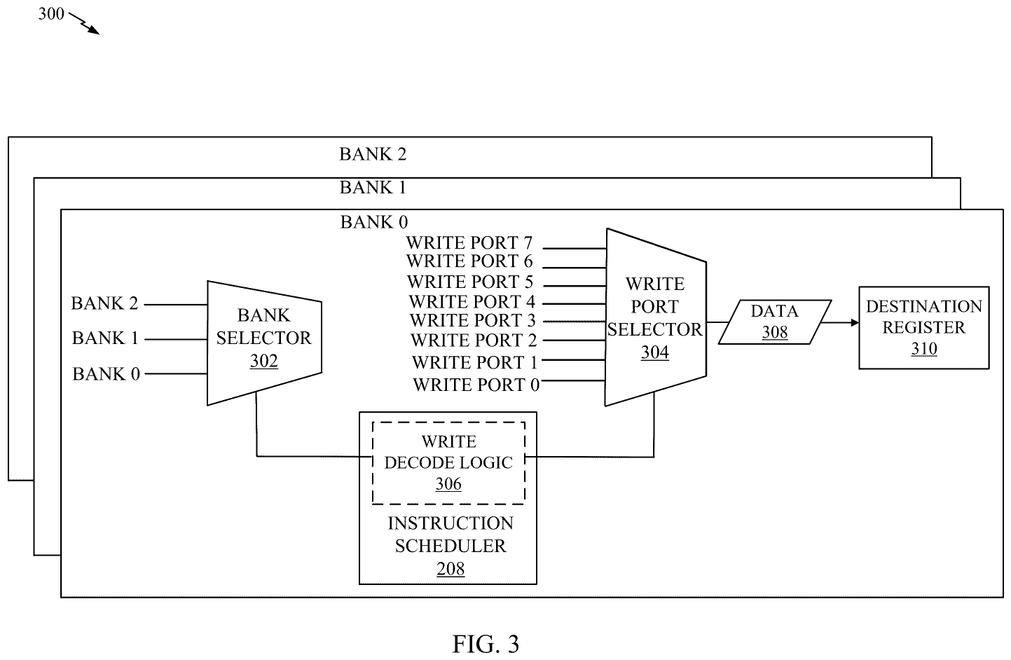

The register file 102 includes a plurality of physical registers. In some aspects, the plurality of physical registers may be used to store operands, intermediate results, and other data required for the concurrent execution of multiple instructions. The register file 102 may include multiple physical ports, with some of the physical ports configured as read ports and the remaining physical ports configured as write ports. As will be discussed in more detail in FIG. 3, the register file 102 may be partitioned into multiple banks of physical registers, with each bank including a subset of the total number of physical registers included in the register file 102.

In some aspects, the control unit 104 may manage the execution of instructions by each of the different execution units 108. For example, the control unit 104 may fetch instructions from memory (e.g., cache memory 106 or main memory), decode the instructions to determine the necessary operations, and then issue control signals to direct the flow of data and the execution of those operations. In some aspects, the control unit 104 may control movement of operands and results between the register file 102, execution units 108, and the cache memory 106. The control unit 104 may also handle the resolution of data dependencies, branch predictions, and other control flow decisions associated with maintaining the correct program execution. In some aspects, the control unit 104 may be configured to handle exceptions, interrupts, and other special events that can occur during program execution. In this manner, the control unit 104 may ensure the overall integrity and reliability of operation of the CPU 100.

The plurality of execution units 108 may be configured to execute (e.g., carry out) operations (e.g., arithmetic, logical, data manipulation) associated with an instruction set architecture for the CPU 100. Examples of these execution units 108 may include, without limitation, an integer execution unit (IXU), an arithmetic logic unit (ALU), a load/store unit (LSU), and any other suitable execution unit that is needed to carry out operations associated with a given instruction set architecture for the CPU 100. In some aspects, each of the plurality of execution units 108 may include multiple pipelines. The multiple pipelines may allow a given execution unit 108 to issue and execute multiple instructions at the same time (e.g., during a single clock cycle) by distributing the multiple instructions across the multiple pipelines.

### Example Architecture for Executing a Sequence of Instructions

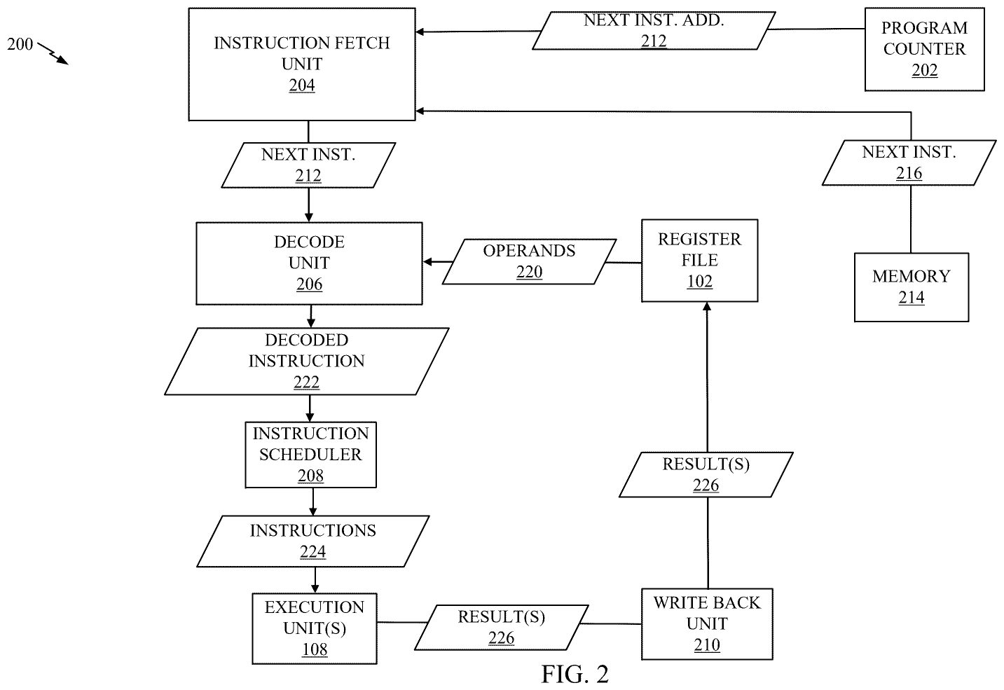

FIG. 2 depicts an example architecture 200 for executing a sequence of instructions (e.g., included in an instruction set architecture) according to some aspects of the present disclosure. The architecture 200 may be implemented in a CPU, such as the CPU 100 discussed above with reference to FIG. 1.

The architecture 200 includes a program counter 202, an instruction fetch unit 204, a decode unit 206, an instruction scheduler 208, and a write back unit 210. The program counter 202 tracks the current location in a program's instruction sequence. For instance, the program counter 202 may hold data 212 to be fetched from memory 214 and executed by the CPU. The data 212 may, for example, include a particular address of the memory 214 that includes the next instruction in the program's instruction sequence.

The instruction fetch unit 204 may obtain the data 212 from the program counter 202 and may access the memory 214 based on the data 212. In some aspects, the memory 214 may be cache memory (e.g., the cache memory 106 in FIG. 1) or a different memory (e.g., main memory). Based on the data 212, the instruction fetch unit 204 may access a particular address of the memory 214. The particular address of the memory 214 may include data 216 that corresponds to the next instruction in the program's instruction sequence.

The decode unit 206 may be configured to decode the data 216 the instruction fetch unit 204 obtained (e.g., fetched) from the memory 214. By decoding the data 216, the decode unit 206 may determine a type (e.g., arithmetic, load/store, etc.) for the next instruction in the program's instruction sequence. The decode unit 206 may also determine the operands involved in the next instruction. For instance, the decode unit 206 may identify source registers specified in the next instruction. The source registers may be included in the register file 102 and the decode unit 206 may access the register file 102 to obtain operands 220 stored in these source registers.

The decode unit 206 may also identify the name of one or more destination registers to which the result of the next instruction will be written. For instance, the one or more destination registers may correspond to one or more registers included in the register file 102. By identifying the name(s) of the destination register(s), the decode unit 206 may generate control signals associated with enabling one or more write-back paths to allow the result of the next instruction to be written (e.g., via the write back unit 210) to the destination register(s) of the register file 102.

In some aspects, the next instruction in the program's instruction sequence may be a complex instruction. In such aspects, the decode unit 206 may translate the complex instruction into a sequence of simpler micro-operations (or micro-instructions) that are easier for the CPU to execute.

After decoding the next instruction in the program's instruction sequence, the decode unit 206 may, in some aspects, dispatch the decoded instruction 222 to the instruction scheduler 208. In some aspects, decoded instruction 222 may include the operands 220 the decode unit 206 obtained (e.g., by accessing the source register(s) of the register file 102) and, if the decoded instruction 222 is a complex instruction, multiple micro-operands the decode unit 206 generated to simplify the complex instruction.

The instruction scheduler 208 may be configured to control dispatch and execution of multiple instructions 224, including the decoded instruction 222. For instance, the instruction scheduler 208 may be configured to determine an optimal order and timing for executing the multiple instructions 224.

In some aspects, as described in more detail with reference to FIG. 4, the CPU may include multiple execution pipelines that allow the CPU to execute multiple instructions 224 concurrently (e.g., at the same time). For instance, each of the execution units 108 of the CPU may include multiple execution pipelines such that each of the execution units 108 may process multiple instructions concurrently. In such aspects, the instruction scheduler 208 may analyze the dependencies between the multiple instructions 224, such as data dependencies and resource conflicts, and use this information to schedule the instructions 224 for execution. By identifying and dispatching instructions that can be executed in parallel, the instruction scheduler 208 helps maximize the utilization of the multiple instructions 224.

The multiple instructions 224 may be executed by one or more of the execution units 108 to generate one or more results 226. For instance, in some aspects, the multiple instructions 224 may be processed in different execution pipelines for the same execution unit 108 (e.g., load/store unit). In other aspects, the multiple instructions 224 may be processed in different execution pipelines for different execution units 108. For example, a first subset of the multiple instructions 224 may be processed in one or more execution pipelines of a first execution unit (e.g., load/store unit), whereas a second subset of the multiple instructions 224 may be processed in one or more execution pipelines of a second execution pipeline (e.g., integer execution unit).

The write back unit 210 may receive the result(s) 226 from the execution unit(s) 108. The write back unit 210 may access the register file 102 to write the result(s) 226 to one or more destination registers included in the register file 102. For example, the result(s) 226 for the decoded instruction 222 (e.g., the next instruction in the program's sequence of instructions) may be written to the destination register(s) the decode unit 206 identified.

The register file 102 includes multiple physical write ports that may be used (e.g., by the write back unit 210) to write results of the multiple instructions being executed by the execution units 108 during a given clock cycle. However, in certain microarchitectures (e.g., such as for superscalar processors), the total number of instructions being executed by the execution units 108 during the given clock cycle may exceed the total number of write ports. Furthermore, as discussed above, increasing the number of physical write ports on the register file 102 may increase the size of the register file 102 and the power consumption of the register file 102, both of which are generally undesirable. As will be discussed below in more detail with reference to FIGS. 3 and 4, the present disclosure is directed to an arbitration scheme for sharing the available write ports such that the register file 102 can accommodate such instances in which the total number of execution pipelines currently executing instructions exceeds the total number write ports on the register file 102.

### Example Register File Having Multiple Banks

FIG. 3 depicts a register file 300 according to some embodiments of the present disclosure. As illustrated, the register file 300 includes multiple banks (e.g., Bank 0, Bank 1, Bank 2), and each of the banks includes a subset of the total number of registers included in the register file 300. The register file 300 may be implemented in the CPU 100 discussed above with reference to FIG. 1.

The register file 300 includes a first multiplexer 302 (e.g., labeled BANK SELECTOR) configured to select one of the multiple banks of the register file 300 and a second multiplexer 304 (e.g., labeled WRITE PORT SELECTOR) configured to select one of the plurality of write ports of the register file 300. The operation of the first multiplexer 302 and the second multiplexer 304 may be controlled using logic 306 (e.g., labeled Write Decode Logic). For instance, the logic 306 may control operation of the first multiplexer 302 and the second multiplexer 304 to write data 308 (e.g., the result of an executed instruction) to a destination register 310 of the register file 102.

In some aspects, the logic 306 may be included in the instruction scheduler 208 discussed above with reference to FIG. 2. Stated another way, the instruction scheduler 208 may be configured to implement the logic 306 to control the timing and execution of the instructions. In other aspects, the logic 306 may be included in a different block (e.g., decode unit 206, write back unit 210) of the architecture 200 discussed above with reference to FIG. 2 or may be standalone (e.g., separate from the decode unit 206, the instruction scheduler 208, the write back unit 210).

In some aspects, the instruction scheduler 208 may control the execution of instructions according to an arbitration scheme in which one or more of the write ports (e.g., P0-P8) of the register file 300 are shared by different instructions being executed by a central processing unit in which the register file 300 is implemented. For example, the arbitration scheme may indicate that the first write port (e.g., WRITE PORT 0) of the register file 300 is shared by an instruction executed by a first execution unit and a second instruction executed by a second execution unit that is different than the first execution unit.

In some aspects, the arbitration scheme may indicate that the first instruction takes priority over the second instruction when a conflict occurs between the two instructions. For instance, the arbitration scheme may define the conflict as occurring when the first instruction (e.g., executed by a first execution unit) and the second instruction (e.g., executed by a second execution unit) are executed (or are scheduled to be executed) at the same time (e.g., during the same clock cycle) and the result of the executed first instruction and the executed second instruction are to be written (or are scheduled to be written) to the same location (e.g. bank) of the register file 300 at the same time.

If the instruction scheduler 208 identifies the conflict before issuing the higher priority instruction (e.g., the first instruction) to the first execution unit and issuing the lower priority instruction (e. g,. the second instruction) to the second execution unit, the instruction schedule 208 may, upon identifying the conflict, issue the higher priority instruction to the first execution unit and ignore (e. g,. not issue) the lower priority instruction. In this manner, the instruction scheduler 208 may avoid wasting computing resources associated with executing the lower priority instruction when the result of executing the lower priority instruction cannot be written to the register file 300 given the conflict in time (e.g., during the same clock cycle) and location (e. g, same bank of the register file 300) with the higher priority instruction.

If the instruction scheduler 208 identifies the conflict after the instructions have already been issued to their respective execution units, the instruction schedule 208 may be configured to replay (e.g., issue again) the lower priority instruction again during a subsequent clock cycle.

### Example Arbitration Scheme for Efficient Register File Write Banking

FIG. 4 depicts a table illustrating an arbitration scheme 400 for a register file having multiple banks according to some embodiments of the present disclosure. For example, the arbitration scheme 400 may be implemented with the register file 300 discussed above with reference to FIG. 3 to efficiently handle concurrent requests to write the results of different executed instructions to the same location (e.g., bank) of the register file at the same time (e.g., during the same clock cycle) using the same write port of the register file. In this manner, the arbitration scheme 400 allows a CPU to issue and execute more instructions during a given clock cycle than there are write ports on the register file 300 without affecting the performance (e.g., decreased throughput) of the CPU. For example, as illustrated in FIG. 4, the arbitration scheme 400 allows as many as 14 different instructions to write to a register file having significantly fewer (e.g., 8) write ports.

In some aspects, the arbitration scheme 400 indicates that a first execution pipeline LSU PIPE 0 of a first execution unit (e.g., Load/Store Unit) and a first execution pipeline IXU PIPE 0 of a second execution unit (e.g., Integer Execution Unit) that is different from the first execution unit share a first write port PO of the register file. The arbitration scheme 400 further indicates that a priority of the first execution pipeline LSU PIPE O associated with the first execution unit is higher (e.g., more important) than a priority of the first execution pipeline IXU PIPE 0 associated with the second execution unit. Thus, the arbitration scheme 400 indicates that an instruction executed in the first execution pipeline LSU PIPE 0 of the first execution unit takes priority over an instruction executed in the first execution pipeline IXU PIPE 0 of the second execution unit when the two execution units are processing the respective instructions at the same time and attempting to concurrently write the results to the same location (e.g., bank) of the register file via the first write port PO.

The arbitration scheme 400 may indicate that a second execution pipeline LSU PIPE 1 associated with the first execution unit and a second execution pipeline associated with the second execution unit share a second write port P1 of the register file 300. The arbitration scheme 400 further indicates that a priority of the second execution pipeline LSU PIPE 1 associated with the first execution unit is higher than a priority of the second execution pipeline IXU PIPE 1 associated with the second execution unit. Thus, an instruction executed in the second execution pipeline LSU PIPE 1 of the first execution unit takes priority over an instruction executed in the second execution pipeline IXU PIPE 1 of the second execution unit when the two execution units are processing the respective instructions at the same time and attempting to concurrently write the results to the same location (e.g., bank) of the register file via the second write port P1.

The arbitration scheme 400 may indicate that a third write port P2 of the register file 300 is assigned to a third execution pipeline IXU PIPE 2 associated with the second execution unit (e.g., Integer Execution Unit). The arbitration scheme 400 may further indicate that a fourth write port P3 of the register file 300 is assigned to a fourth execution pipeline IXU PIPE 3 associated with the second execution unit (e.g., Integer Execution Unit).

Furthermore, in certain aspects, the third execution pipeline IXU PIPE 2 and the fourth execution pipeline IXU PIPE 3 may span multiple clock cycles and, for at least this reason, the arbitration scheme 400 may indicate that the third write port P2 and the fourth write port P3 are reserved for the third execution pipeline IXU PIPE 2 and the fourth execution pipeline IXU PIPE 3, respectively. Stated another way, the third execution pipeline IXU PIPE 2 may not share the third write port P2 with another execution pipeline of the CPU and the fourth execution pipeline IXU PIPE 3 may not share the fourth write port P3 with another execution pipeline of the CPU.

The arbitration scheme 400 may indicate that a third execution pipeline LSU PIPE 2 associated with the first execution unit (e.g., Load Store Unit) and a fifth execution pipeline IXU PIPE 4 associated with the second execution unit (e.g., Integer Execution Unit) share a fifth write port P4 of the register file 300. The arbitration scheme 400 may further indicate that a priority of the third execution pipeline LSU PIPE 2 is higher (e.g., more important) than a priority of the fifth execution pipeline IXU PIPE 4. Thus, an instruction executed in the third execution pipeline LSU PIPE 2 of the first execution unit takes priority over an instruction executed in the fifth execution pipeline IXU PIPE 4 of the second execution unit when the two execution units are processing the respective instructions at the same time and attempting to concurrently write the results to the same location (e.g., bank) of the register file via the fifth write port P4.

The arbitration scheme 400 may indicate 400 may indicate that a fourth execution pipeline LSU PIPE 3 associated with the first execution unit (e.g., Load Store Unit) and a sixth execution pipeline IXU PIPE 5 associated with the second execution unit share a sixth write port P5 of the register file 300. The arbitration scheme 400 may further indicate that a priority of the fourth execution pipeline LSU PIPE 3 is higher (e.g., more important) than a priority of the sixth execution pipeline IXU PIPE 5. Thus, an instruction executed in the fourth execution pipeline LSU PIPE 3 of the first execution unit takes priority over an instruction executed in the sixth execution pipeline IXU PIPE 5 of the second execution unit when the two execution units are processing the respective instructions at the same time and attempting to concurrently write the results to the same location (e.g., bank) of the register file via the sixth write port P5.

The arbitration scheme 400 may indicate that a first execution pipeline MUL/MLA PIPE 0 of a third execution unit (e.g., Integer Multiplication Unit) and a first execution pipeline VECTOR-TO-INT. PIPE 0 of a fourth execution (e.g., Vector-to-Integer Unit) share a seventh write port P6 of the register file. The arbitration scheme 400 may further indicate that the first execution pipeline MUL/MLA PIPE 0 associated with the third execution unit takes priority over the first execution pipeline VECTOR-TO-INT PIPE 0 of the fourth execution unit. Thus, an instruction executed in the first execution pipeline MUL/MLA PIPE 0 of the third execution unit takes priority over an instruction executed in the first execution pipeline MUL/MLA PIPE 0 of the second execution unit when the two execution units are processing the respective instructions at the same time and attempting to concurrently write the results to the same location (e.g., bank) of the register file via the seventh write port P6.

The arbitration scheme 400 may indicate that a second execution pipeline MUL/MLA PIPE 1 of the third execution unit (e.g., Integer Multiplication Unit) and a second execution pipeline VECTOR-TO-INT. PIPE 1 of the fourth execution (e.g., Vector Execution Unit) share an eight write port P7 of the register file. The arbitration scheme 400 may further indicate that the second execution pipeline MUL/MLA PIPE 1 associated with the third execution unit takes priority over the second execution pipeline VECTOR-TO-INT PIPE 1 of the fourth execution unit. Thus, an instruction executed in the second execution pipeline MUL/MLA PIPE 1 of the third execution unit takes priority over an instruction executed in the second execution pipeline MUL/MLA PIPE 1 of the second execution unit when the two execution units are processing the respective instructions at the same time and attempting to concurrently write the results to the same location (e.g., bank) of the register file via the eight write port P7.

As previously stated, the arbitration scheme 400 of FIG. 4 illustrates how the disclosed techniques allow a register file, such as the register file 300 discussed above with reference to FIG. 3, to accommodate a greater number of execution pipelines without requiring a dedicated write port for all the different pipelines. Thus, the disclosed techniques allow an existing register file to accommodate a greater number of execution pipelines than there are available write ports on the register file without affecting the performance (e.g., throughput) of the CPU. Additionally, the arbitration scheme 400 may work with instructions that require results to be written to different banks of the register file. For example, the arbitration scheme 400 may accommodate a load-store instruction executed by a load-store execution unit to write to two separate destinations (e.g. two separate registers) of the register file. For example, the arbitration scheme 400 can accommodate the load-store instruction by ensuring the two destinations are mapped to different banks of the register file. For example, a tag (e.g., a register tag) associated with the first destination (e.g., first register file) may be mapped to a register included in a first bank of the register file, whereas a tag (e.g., register tag) associated with the second destination may be mapped to a register included in a second bank of the register file. In this manner, a single write port of the register file can accommodate such instructions (e.g., load-store) without causing a write bank conflict and furthermore allows such instructions (e.g., load-store) to share the single write port with a different instruction (e.g., integer execution) as illustrated in the table in FIG. 4.

### Example Method for Efficient Register File Write Banking

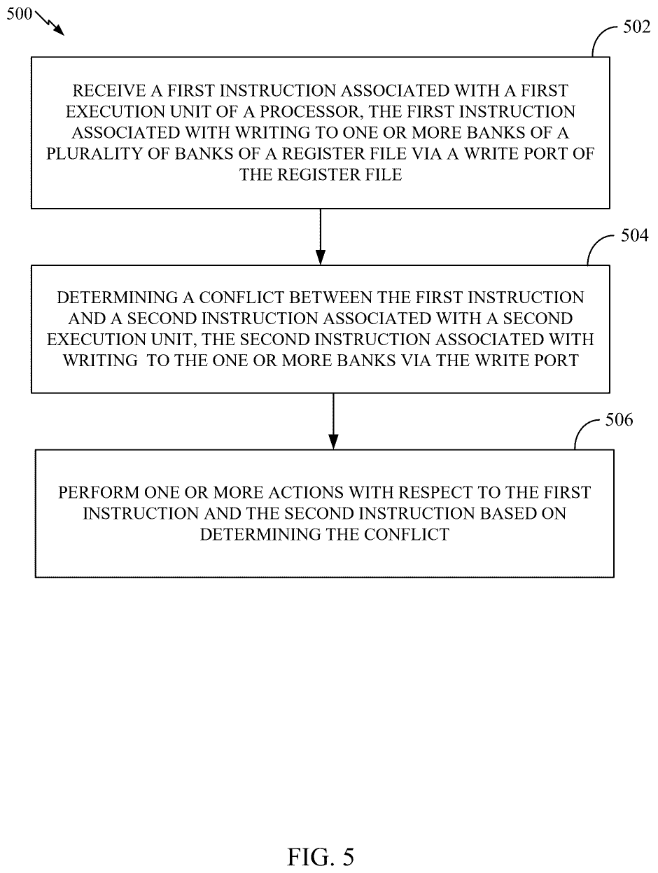

FIG. 5 is a diagram depicting an example method 500 of efficient register file write banking according to various aspects of the present disclosure. For example, the method 500 may be performed by the CPU (e.g., the instruction scheduler 208 thereof) discussed above with reference to FIG. 2 through FIG. 4. Furthermore, although FIG. 5 depicts steps performed in a particular order for purposes of illustration and discussion, the method 500 discussed herein is not intended to be limited to any particular order or arrangement. One skilled in the art, using the disclosure provided herein, will appreciate that various steps of the method 500 can be omitted, rearranged, combined and/or adapted in various ways without deviating from the scope of the present disclosure.

At 502, the method 500 includes receiving a first instruction associated with writing first data to one or more banks of a plurality of banks of a register file via a write port of the register file.

At 504, the method 500 includes determining a conflict between the first instruction and a second instruction associated with writing second data the one or more banks via the write port.

At 506, the method 500 includes performing one or more actions with respect to the first instruction and the second instruction based on determining the conflict. In some aspects, the one or more actions may include issuing the first instruction and ignoring or replaying the second instruction.

### Example Processing System

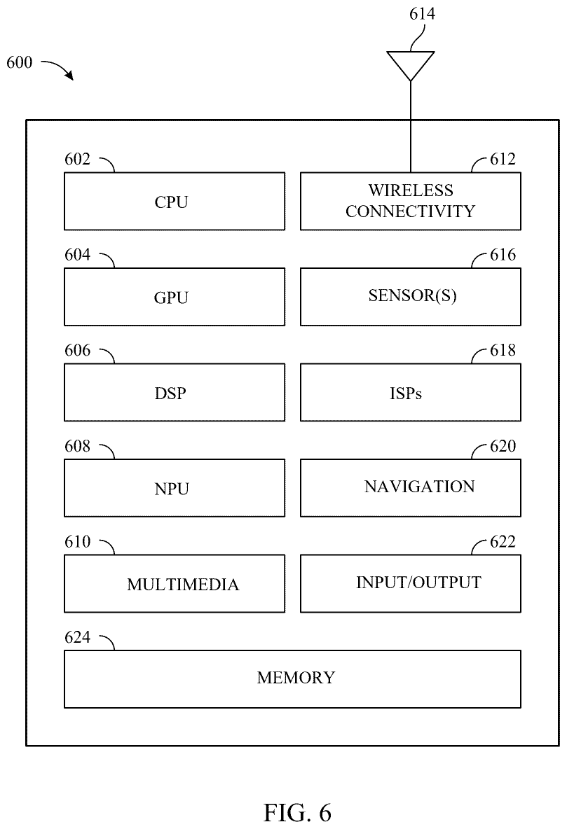

In some aspects, the central processing unit discussed above with reference to FIG. 1 may be included in a device or processing system. FIG. 6 depicts an example processing system 600. Although depicted as a single system for conceptual clarity, in some aspects, as discussed above, the operations described below with respect to the processing system 600 may be distributed across any number of devices or systems.

The processing system 600 includes a central processing unit (CPU) 602. Instructions executed at the CPU 602 may be loaded, for example, from a memory 624 associated with the CPU 602.

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### EXAMPLE CLAUSES

In addition to the various aspects described above, specific combinations of aspects are within the scope of the disclosure, some of which are detailed below:

Aspect 1: A method for writing to a register file of a processor, comprising: receiving a first instruction associated with a first execution unit of the processor, the first instruction associated with writing to one or more banks of a plurality of banks of the register file via a write port of the register file; determining a conflict between the first instruction and a second instruction associated with a second execution unit, the second instruction associated with writing to the one or more banks via the write port; and performing one or more actions with respect to the first instruction and the second instruction based on determining the conflict.

Aspect 2: The method of Aspect 1, wherein performing one or more actions comprises: issuing the first instruction; and blocking the second instruction from issuing or replaying the second instruction after issuing the first instruction.

Aspect 3: The method of Aspect 1 or 2, wherein: the first execution unit is a load-store unit; and the first instruction comprises a load-store instruction to write to a first register of the register file and to write to a second register of the register file.

Aspect 4: The method of Aspect 3, wherein issuing the load-store instruction comprises: mapping the first register to a first bank of the plurality of banks; mapping the second register to a second bank of the plurality of banks; writing data associated with the load-store instruction to the first bank via the write port; and writing data associated with the load-store instruction to the second bank via the write port.

Aspect 5: The method of any of Aspects 1 to 4, wherein the first execution unit is a load-store unit; and the second execution unit is an integer execution unit.

Aspect 6: The method of Aspect 5, wherein the integer execution unit comprises an arithmetic logic unit.

Aspect 7: The method of Aspect 1, wherein the first execution unit is a multiply unit or a multiply-accumulate-unit; and the second execution unit is a vector execution unit.

Aspect 8: An apparatus, comprising: a processor comprising a plurality of execution units and a register file having plurality of banks and a plurality of write ports, the processor configured to: receive a first instruction associated with a first execution unit of the plurality of execution units, the first instruction associated with writing to one or more banks of the plurality of banks of the register file via a write port of the plurality of write ports; determine a conflict between the first instruction and a second instruction associated with a second execution unit of the plurality of execution units, the second instruction associated with writing to the one or more banks via the write port; and perform one or more actions with respect to the first instruction and the second instruction based on determining the conflict.

Aspect 9: The apparatus of Aspect 8, wherein performing one or more actions comprises: issue the first instruction; and block the second instruction from issuing or replay the second instruction after issuing the first instruction.

Aspect 10: The apparatus of Aspect 8 or 9, wherein: the first execution unit is a load-store unit; and the first instruction comprises a load-store instruction to write to a first register of the register file and to write to a second register of the register file.

Aspect 11: The apparatus of Aspect 10, wherein issue the load-store instruction comprises: map the first register to a first bank of the plurality of banks; map the second register to a second bank of the plurality of banks; write data associated with the load-store instruction to the first bank via the write port; and write data associated with the load-store instruction to the second bank via the write port.

Aspect 12: The apparatus of any of Aspects 8 to 11, wherein: the first execution unit is a load-store unit; and the second execution unit is an integer execution unit.

Aspect 13: The apparatus of Aspect 12, wherein the integer execution unit comprises an arithmetic logic unit.

Aspect 14: The apparatus of Aspect 8, wherein: the first execution unit is a multiply unit or a multiply-accumulate-unit; and the second execution unit is a vector execution unit.

Aspect 15: A non-transitory computer-readable medium comprising instructions to be executed in a processor, wherein the instructions when executed in the processor cause the processor to: receive a first instruction associated with a first execution unit of the processor, the first instruction associated with writing to one or more banks of a plurality of banks of a register file via a write port of the register file; determine a conflict between the first instruction and a second instruction associated with a second execution unit, the second instruction associated with writing to the one or more banks via the write port; and perform one or more actions with respect to the first instruction and the second instruction based on determining the conflict.

Aspect 16: The non-transitory computer-readable medium of Aspect 15, wherein performing one or more actions comprises: issue the first instruction; and block the second instruction from issuing or replay the second instruction after issuing the first instruction.

Aspect 17: The non-transitory computer-readable medium of Aspect 15, wherein: wherein: the first execution unit is a load-store unit; and the first instruction comprises a load-store instruction to write to a first register of the register file and to write to a second register of the register file.

Aspect 18: The non-transitory computer-readable medium of Aspect 17, wherein issue the first instruction comprises: map the first register to a first bank of the plurality of banks; map the second register to a second bank of the plurality of banks; write data associated with the load-store instruction to the first bank via the write port; and write data associated with the load-store instruction to the second bank via the write port.

Aspect 19: The non-transitory computer-readable medium of Aspect 15, wherein the first execution unit is a load-store unit; and the second execution unit is an integer execution unit.

Aspect 20: The non-transitory computer-readable medium of Aspect 19, wherein the integer execution unit comprises an arithmetic logic unit.

### Additional Considerations

The various operations of methods described above may be performed by any suitable means capable of performing the corresponding functions. The means may include various hardware and/or software components(s) module(s), including, but not limited to a circuit or processor. Generally, where there are operations illustrated in figures, those operations may have corresponding counterpart means-plus-function components with similar numbering.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining”may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for writing to a register file of a processor, comprising:
receiving a first instruction associated with a first execution unit of the processor, the first instruction associated with writing to one or more banks of a plurality of banks of the register file via a write port of the register file;
determining a conflict between the first instruction and a second instruction associated with a second execution unit, the second instruction associated with writing to the one or more banks via the write port; and
performing, based on determining the conflict, one or more actions with respect to the first instruction and the second instruction according to an arbitration scheme that is specific to the write port.

2. The method of claim 1, wherein performing one or more actions comprises:
issuing the first instruction; and
blocking the second instruction from issuing or replaying the second instruction after issuing the first instruction.

3. The method of claim 2, wherein:
the first execution unit is a load-store unit; and
the first instruction comprises a load-store instruction to write to a first register of the register file and to write to a second register of the register file.

4. The method of claim 3, wherein issuing the load-store instruction comprises:
mapping the first register to a first bank of the plurality of banks;
mapping the second register to a second bank of the plurality of banks;
writing data associated with the load-store instruction to the first bank via the write port; and
writing data associated with the load-store instruction to the second bank via the write port.

5. The method of claim 1, wherein:
the first execution unit is a load-store unit; and
the second execution unit is an integer execution unit.

6. The method of claim 5, wherein the integer execution unit comprises an arithmetic logic unit.

7. The method of claim 1, wherein:
the first execution unit is a multiply unit or a multiply-accumulate-unit; and
the second execution unit is a vector execution unit.

8. An apparatus, comprising:
a processor comprising a plurality of execution units and a register file having plurality of banks and a plurality of write ports, the processor configured to:
receive a first instruction associated with a first execution unit of the plurality of execution units, the first instruction associated with writing to one or more banks of the plurality of banks of the register file via a write port of the plurality of write ports;
determine a conflict between the first instruction and a second instruction associated with a second execution unit of the plurality of execution units, the second instruction associated with writing to the one or more banks via the write port; and
perform, based on determining the conflict, one or more actions with respect to the first instruction and the second instruction according to an arbitration scheme that is specific to the write port.

9. The apparatus of claim 8, wherein the one or more actions comprises:
issue the first instruction; and
block the second instruction from issuing or replay the second instruction after issuing the first instruction.

10. The apparatus of claim 8, wherein:
the first execution unit is a load-store unit; and
the first instruction comprises a load-store instruction to write to a first register of the register file and to write to a second register of the register file.

11. The apparatus of claim 10, wherein issue the load-store instruction comprises:
map the first register to a first bank of the plurality of banks;
map the second register to a second bank of the plurality of banks via the write port;
write data associated with the load-store instruction to the first bank via the write port; and
write data associated with the load-store instruction to the second bank via the write port.

12. The apparatus of claim 8, wherein:
the first execution unit is a load-store unit; and
the second execution unit is an integer execution unit.

13. The apparatus of claim 12, wherein the integer execution unit comprises an arithmetic logic unit.

14. The apparatus of claim 8, wherein:
the first execution unit is a multiply unit or a multiply-accumulate-unit; and
the second execution unit is a vector execution unit.

15. A non-transitory computer-readable medium comprising instructions to be executed in a processor, wherein the instructions when executed in the processor cause the processor to:
receive a first instruction associated with a first execution unit of the processor, the first instruction associated with writing to one or more banks of a plurality of banks of a register file via a write port of the register file;
determine a conflict between the first instruction and a second instruction associated with a second execution unit, the second instruction associated with writing to the one or more banks via the write port; and
performing, based on determining the conflict, one or more actions with respect to the first instruction and the second instruction according to an arbitration scheme that is specific to the write port.

16. The non-transitory computer-readable medium of claim 15, wherein the one or more actions comprise:
issue the first instruction; and
block the second instruction from issuing or replay the second instruction after issuing the first instruction.

17. The non-transitory computer-readable medium of claim 15, wherein:
the first execution unit is a load-store unit; and
the first instruction comprises a load-store instruction to write to a first register of the register file and to write to a second register of the register file.

18. The non-transitory computer-readable medium of claim 17, wherein issue the load-store instruction comprises:
map the first register to a first bank of the plurality of banks;
map the second register to a second bank of the plurality of banks;
write data associated with the load-store instruction to the first bank via the write port; and
write data associated with the load-store instruction to the second bank via the write port.

19. The non-transitory computer-readable medium of claim 15, wherein:
the first execution unit is a load-store unit; and
the second execution unit is an integer execution unit.

20. The non-transitory computer-readable medium of claim 19, wherein the integer execution unit comprises an arithmetic logic unit.
